(19) United States
(12) Patent Application Publication
(10) Pub. No.: US 2015/0070508 A1
(43) Pub. Date: Mar. 12, 2015

(54) OUTPUT CIRCUIT AND METHOD OF DETECTING WHETHER LOAD CONNECTED TO CONNECTING PORT AND RELATED VIDEO OUTPUT CIRCUIT

(71) Applicant: ALI CORPORATION, Hsinchu (TW)

(72) Inventors: Chih-Yuan Hsu, Hsinchu (TW); Yu-Shin Wang, Hsinchu (TW)

(73) Assignee: ALI CORPORATION, Hsinchu (TW)

(21) Appl. No.: 14/155,389

(22) Filed: Jan. 15, 2014

(30) Foreign Application Priority Data
Sep. 6, 2013 (CN) 201310403474.6

(51) Int. Cl. H04N 17/00

(52) U.S. Cl. CPC H04N 17/00
USPC 348/180

(57) ABSTRACT

Described in example embodiments herein are techniques for detecting a connection between a load and a connecting port. In accordance with an example embodiment, an output circuit is able to detect a corresponding connecting port includes a voltage output stage, a reference current source and a determination circuit. The voltage output stage is arranged to output a voltage signal to an output end of the output circuit. The reference current source is arranged to selectively provide a first current to the output end. The determination circuit is arranged to generate a determination signal according to whether a second voltage signal is identical to a first voltage signal that is caused by the first current flowing into the output end. The determination signal indicates the load is connected to the connecting port when the second voltage signal is not identical to the first voltage signal.

### BACKGROUND OF THE INVENTION

1. Field of the Invention

The present invention relates to an output circuit for a signal processing system, and more particularly, to an output circuit of a signal processing system capable of detecting whether a load is connected to a connecting port of the output circuit.

2. Description of the Prior Art

Typically, multimedia playback devices, such as set top boxes, output video and audio signals to display devices through their connecting ports. Since there are a variety of different video signaling standards used by the display devices, the multimedia playback devices usually have several connecting ports complying with these different video signaling standards, such as, composite video, S-Video, component video, digital visual interface (DVI) and high definition multimedia interface (HDMI) standards. Inmost cases, some of the connecting ports of a multimedia playback device are not connected to any display device. However, output circuits or signal processing circuits corresponding to these “un-connected” connecting ports still keep operating since they are not informed of connection state (i.e., whether the connecting port is connected to the display device). As such, the output circuits or signal processing circuits operate to consume power even if they do not need to generate output signals for the display device. This leads to unnecessary power consumption. To reduce the unnecessary power consumption, there exist several detection techniques for detecting the connection state of the connecting port. These detection techniques further allows the multimedia playback device either to turn off the output circuit/the signal processing circuit or to make the output circuit/the signal processing circuit enter a power saving mode while the corresponding connecting port is detected to be un-connected.

A common detection method is to dispose a mechanically-driven switch inside the connecting port. The mechanically-driven switch can generate a current signal or a voltage signal when a connector of a transmission cable is plugged into the connecting port. This is achieved by a contact spring of the mechanically-driven switch trigging a signal generation circuit to be shorted or opened, thereby generated a detection signal. The detection signal is sent back to the output circuit/the signal processing circuit and accordingly controls the operating of the output circuit/the signal processing circuit. The output circuit/the signal processing circuit can be turned off as long as it does not receive the detection signal generated by the mechanically-driven switch. On the other hand, when the transmission cable is plugged into the connecting port, the output circuit/the signal processing circuit will be turned on. However, such mechanically-driven switch and related signal generation circuit increase the manufacturing cost. Also, this detection method requires the output circuit/the signal processing circuit to provide additional signal pin to receive the detection signal generated by the mechanically-driven switch. Therefore, the layout of the output circuit and the signal process circuit become even more complicated, and what is even worse, the mechanically-driven switch may wear down or break down because of repeatedly uses.

In order to solve the above problem, U.S. Patent Application (No. 2005/0036758) provides a detection method performed inside the output circuit. This detection method does not need the additional signal pin as well as the mechanically-driven switch such that the manufacturing cost will be reduced and there will be no wearing-down issue. However, this detection method is only suitable to the output circuit that outputs the current signal but not to the output circuit that outputs the voltage signal.

China Patent Application (No. 201210117225.6) proposes a detection circuit that is suitable to the output circuit that outputs the voltage signal. Also, there is no need to assign an additional signal pin of the output circuit for receiving the detection signal. In this architecture, a comparator is employed for comparing currents flowing transistors in a complementary metal-oxide-semiconductor (CMOS) circuit in the output circuit. A pair of current mirror duplicates currents flowing through P-type and N-type transistors of the CMOS circuit. The duplicated currents are sent to the comparator which will determine whether the duplicated currents are identical. Based on the current difference between the duplicated currents, it can be determined whether the connecting port is connected to the load. However, in this architecture, as transistors are operated in linear region, the current difference may be not considerable to reflect that the connecting port has been connected.

Hence, there are several shortcomings in the conventional art that need to be improved.

### SUMMARY OF THE INVENTION

With this in mind, it is one objective of the present invention to provide a detection technique that is suitable to the output circuit that generates output in voltage form. The present invention detects whether a transmission cable is plugged into a connecting port from the inside of the output circuit. In addition to detecting the connection state between the transmission cable and the connecting port, the present invention is also able to detect whether the transmission cable is further connected to another device (e.g. a display device). In particular, the present invention utilizes a reference current source to provide a reference current to an output end that is coupled to the connecting port, and determines whether a load is connected to the connecting port according to a voltage signal at the output end.

According to one aspect of the present invention, there is provided an output circuit, comprising: a voltage output stage, a reference current source and a determination circuit. The voltage output stage is arranged to output a voltage signal to an output end of the output circuit, wherein the output end is coupled to a connecting port. The reference current source is coupled to the output end, and is arranged to selectively provide a first current to the output end. The determination circuit is coupled to the output end, and is arranged to generate a determination signal according to whether a second voltage signal is identical to a first voltage signal that is caused by the first current flowing into the output end, wherein the determination signal indicates a load is connected to the connecting port when the second voltage signal is not identical to the first voltage signal.

According to another aspect of the present invention, there is provided a method of detecting whether a load is connected to a connecting port corresponding to an output circuit, comprising: selectively providing a first current to an output end, wherein the output end is coupled to the connecting port; and generating a determination signal according to whether a second voltage signal is identical to a first voltage signal that is caused by the first current flowing into the output end, wherein the determination signal indicates the load is connected to the connecting port when the second voltage signal is not identical to the first voltage signal.

According to still another aspect of the present invention, there is provided a video output circuit that is arranged for outputting a video output signal, comprising: a digital-to-analog converter, a voltage output stage, a reference current source and a determination circuit. The digital-to-analog converter is arranged to convert a digital video signal into an analog video signal. The voltage output stage is coupled to the digital-to-analog converter, and is arranged to receive the analog video signal and generate the video output signal to an output end corresponding to the output circuit, wherein the output end coupled to is coupled to a connecting port. The reference current source is coupled to the output end, and is arranged to selectively provide a first current to the output end. The determination circuit is coupled to the output end, and is arranged to generate a determination signal according to whether a second voltage signal is identical to a first voltage signal that is caused by the first current flowing into the output end, wherein the determination circuit generates the determination signal indicating a load is connected to the connecting port when the second voltage signal is not identical to the first voltage signal, thereby allowing the digital-to-analog converter to enter a power saving mode.

By constructing as described above, the output circuit is capable of detecting whether the load is connected to the connecting port and controlling the operation of internal circuit block/module according to the detection result, thereby reducing the power consumption of the output circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of an output circuit according to one embodiment of the present invention.

FIG. 2 and FIG. 3 illustrate how to configure the second voltage signal of the determination circuit in different conditions.

FIG. 4 is a timing chart of control signals of the output circuit according to one embodiment of the present invention.

FIG. 5 is a flow chart of a method according to one embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

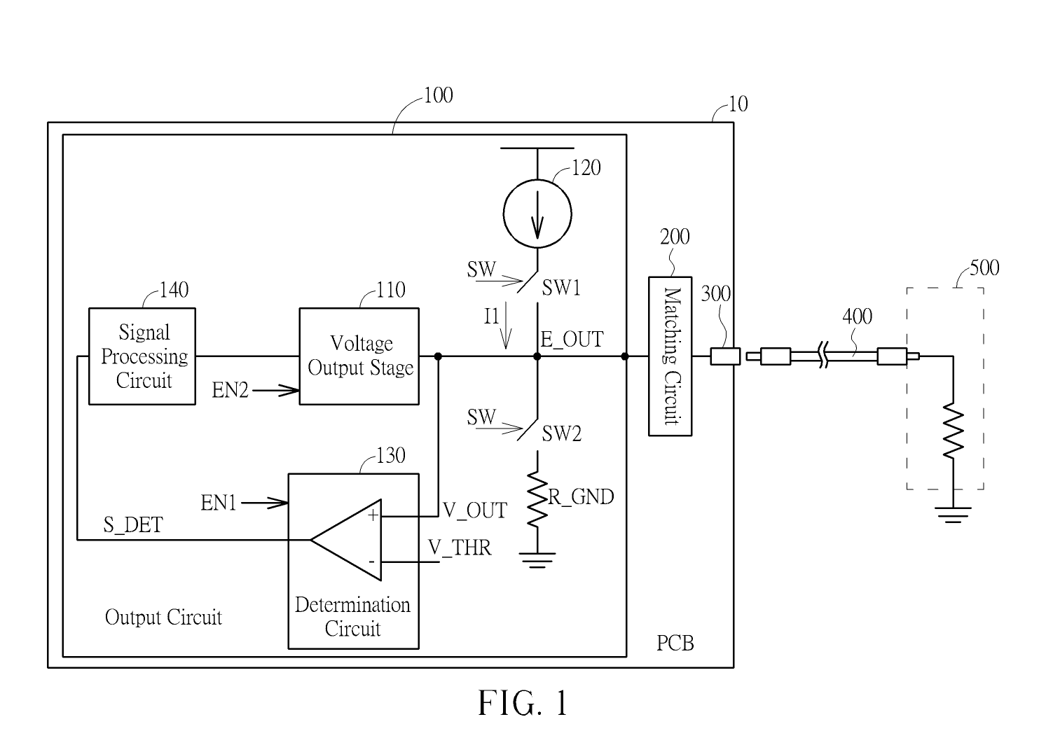

Please refer to FIG. 1, which schematically illustrates an output circuit according to one embodiment of the present invention. As shown, an output circuit 100 comprises a voltage output stage 110, a reference current source 120 and a determination circuit 130. The output circuit 100 transmits an output signal generated by the voltage output stage 110 through an output end E_OUT to an external device. The output end E_OUT may be a signal pin/pad/contact of the output circuit 100. Further, the output circuit 100 may be mounted on a printed circuit board (PCB) 10, and outputs the output signal to a connecting port 300 through traces and wires of the PCB 10. The connecting port 300 is arranged to connect to a connector of a transmission cable 400. The output signal can be transmitted to the external device 500 (e.g. a display device) which is also connected to the transmission cable 400. The reference current source 120 is coupled to the voltage output stage 110. Through a switch SW1, the reference current source 120 selectively provides a first current I1 to the output end E_OUT. Additionally, the output end E_OUT is selectively connected to a first resistor R_GND through a switch SW2.

Once the reference current source 120 provides the first current I1 to the output end E_OUT through the switch SW1 and the output end E_OUT is connected to the first resistor R_GND through the switch SW2, a first voltage signal V_OUT is built up at the output end E_OUT. At this time, if a load is not connected to the connecting port 300 (i.e., the transmission cable 400 is not plugged into the connecting port 300, or the transmission cable 400 is plugged into the connecting port 300 but the transmission cable 400 is not connected to the external device 500), an amount of the first voltage signal V_OUT at the output end E_OUT will be different from the case that the connecting port 300 and the external device 500 are connected through the transmission cable 400. The determination circuit 130 generates a determination signal S_DET according to whether the first voltage signal V_OUT is identical to a second voltage signal V_THR. When the first voltage signal V_OUT is not identical to the second voltage signal V_THR, the determination signal S_DET is indicative of the load being currently connected to the connecting port 300. According to various embodiments of the present invention, the determination circuit 130 could be implemented with a comparator or other circuit having same function.

There are several ways of configuring the second voltage signal V_THR. Components of a matching circuit 200 determine how to configure of the second voltage signal V_THR. Typically, the matching circuit 200 includes a matching resistor R and/or a coupling capacitor C. The matching resistor R is intended for impedance matching for the load (e.g. the external device 500) with respect to the output circuit 100. The coupling capacitor is intended for establishing a proper DC level. Generally, a DC level of zero (i.e., zero DC bias) can be established by the coupling capacitor C. However, in some cost-oriented architecture, the matching circuit 200 comprises a resistor only and does not comprises a coupling capacitor C. Depending on what is included in the matching circuit 200, the determination circuit 130 uses different judging conditions to determine the connection state between the load and the connecting port 300. Different ways of configuring the second voltage signal V_THR will be illustrated according to the following embodiments.

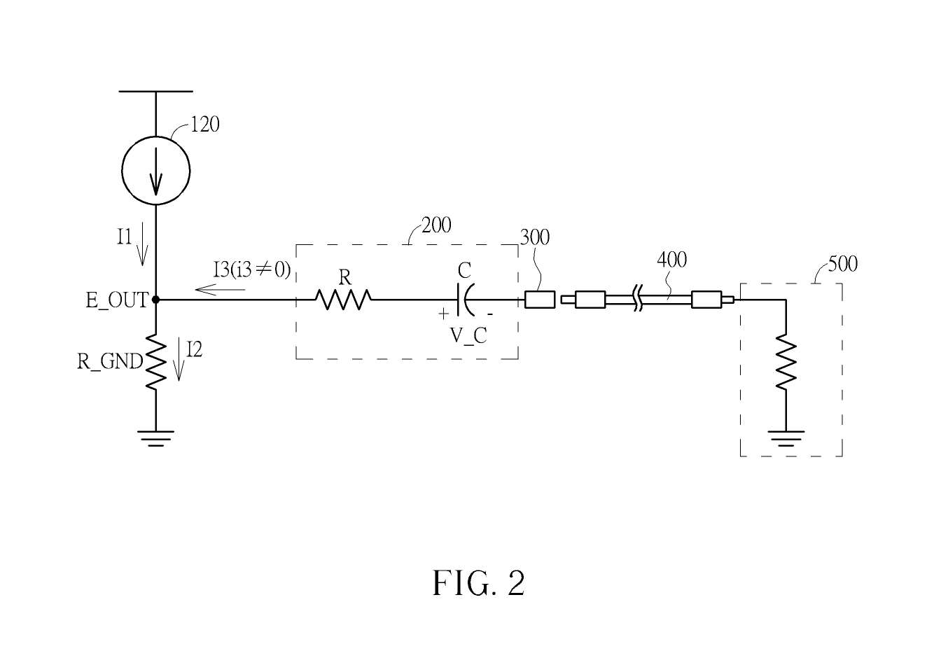

Please refer to FIG. 2, which illustrates a simplified circuit diagram of the reference current source 120, the output end E_OUT, the matching circuit 200 and the load (e.g. the external device 500). In this case, the matching circuit 200 includes the matching resistor R and the coupling capacitor C. In such case, when the signal is outputted from the output end E_OUT to the load, charges could be accumulated in the capacitor C, and thus there will be a potential difference V_C between ends of the capacitor C. When the load is connected to the connecting port 300, the potential difference VC will lead to a third current I3 to flow into the output end E_OUT. As such, when the load is connected to the connecting port 300, the second current I2 flowing through the first resistor R_GND will be a summation of the first current I1 and the third current I3 (i2=i1+i3), the first voltage signal V_OUT at the output end E_OUT will be i2*r=(i1+i3)*r, where i1 is an amount of the first current I1 generated by the reference current source 120, i2 is an amount of the second current I2, i3 is an amount of the third current I3, r is the resistance of the first resistor R_GND. Moreover, when the load is not connected to the connecting port 300 (i3=0), the first voltage signal V_OUT at the output end E_OUT will be i2*r=(i1)*R Therefore, when the matching circuit 200 includes the matching resistor R and the coupling capacitor C, the increasing of the first voltage signal V_OUT represents that the connection state between the connecting port 300 and the load change from un-connected to connected. The determination circuit 130 can configure the second voltage signal V_THR in accordance with the value of “i1*r”. As long as the first voltage signal V_OUT at the output end E_OUT exceeds the second voltage signal V_THR, it can be determined that the load is connected to the connecting port 300. In another embodiment, the second voltage signal V_THR also can be configured with a fixed value that is determined by the user in advance. Alternatively, it is also possible to configure the second voltage signal V_THR according to the value of “(i1+k*i3)*r”, where the factor k is a constant that is smaller than or equal to 1, which also can be determined by the user.

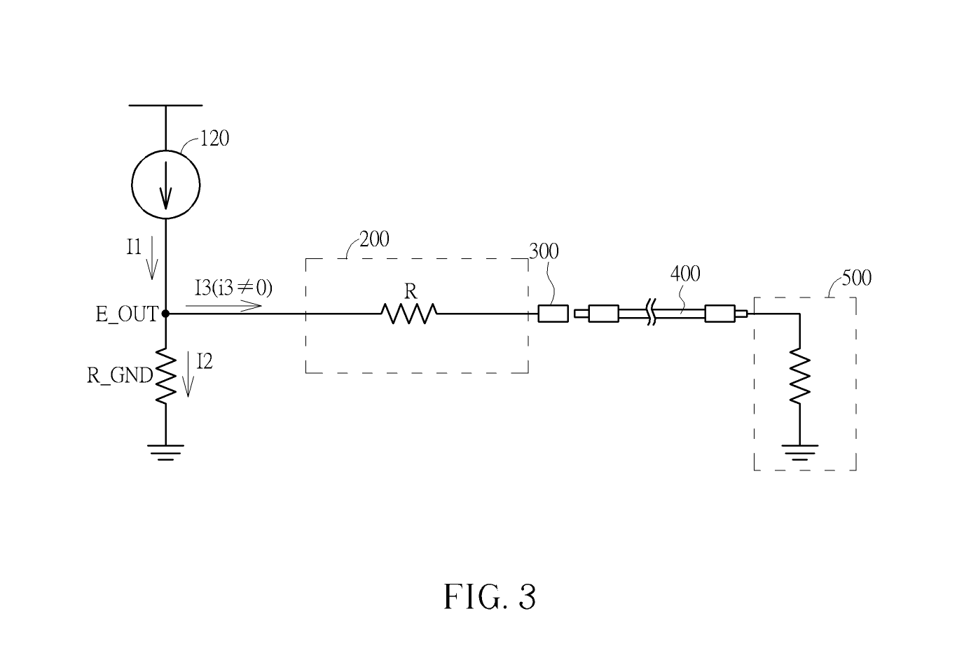

Please refer to FIG. 3, which illustrates an embodiment where the matching circuit 200 comprises the matching resistor R only. In such case, when the load is connected to the connecting port 300, the first current I1 will be distributed, so as to generate the second current I2 flowing through the first resistor R_GND and the third current I3 flowing into the load. The amount of the second current I2 will be the difference between the amount of the first current I1 and the amount of the third current I3 (i2=i1−i3). At this time, the voltage level of the output end E_OUT will be V_OUT=i2*r=(i1−i3)*r, wherein it is the amount of the first current I1 generated by the reference current source 120, i2 is the amount of the second current I2, i3 is the amount of the third current I3, r is the resistance of the first resistor R_GND. When the load is not connected to the connecting port 300, the voltage V_OUT at the output end E_OUT will be i2*r=i1*r. In view of this, when the matching circuit 200 only includes the matching resistor R, and the voltage V_OUT at the output end E_OUT decreases, it represents that the connection state between the connecting port 300 and the load change from un-connected to connected. Hence, the determination circuit 130 can configure the second voltage signal V_THR in accordance with the value of “i1*r”. When the voltage signal V_OUT at the output end E_OUT is smaller than the second voltage signal V_THR, it can be determined that the load is connected to the connecting port 300. In another embodiment, the second voltage signal V_THR can be configured with a fixed value that is determined by the user in advance. Alternatively, it is also possible to configure the second voltage signal V_THR according to the value of “(i1−k*i3)*r”, where the factor k is a constant that is smaller than or equal to 1, which also can be determined by the user.

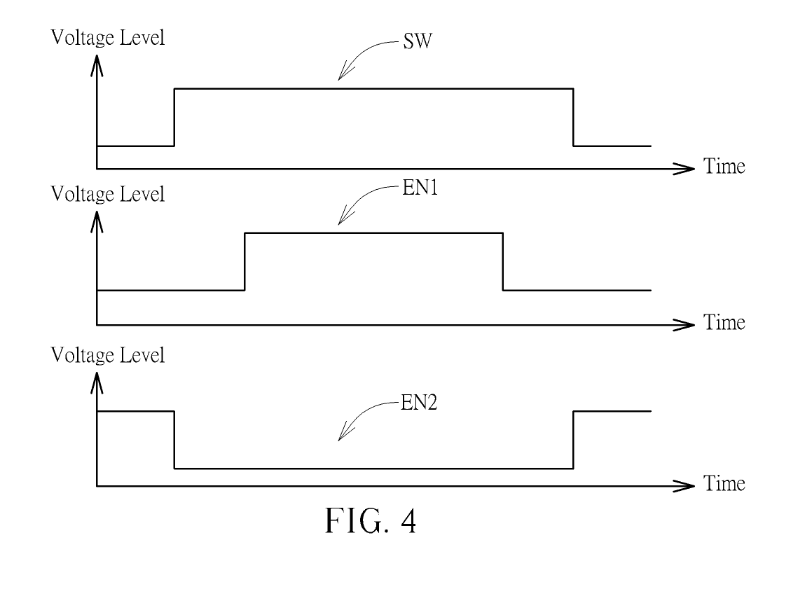

In one embodiment, to prevent the operation of the voltage output stage 110 from being interfered with by the determination circuit 130, the voltage output stage 110 will be turned off before the comparator in the determination circuit 130 starts to compare the first voltage signal V_OUT with the second voltage signal V_THR. Furthermore, when the voltage output stage 110 enters a normal operation mode, the reference current source 120 and the first resistor R_GND are taken off from the output end E_OUT. A timing chart regarding control signals in the output circuit 100 is illustrated FIG. 4, wherein the control signal SW is used for controlling the switches SW1 and SW2, the enablement signals EN1 and EN2 is used respectively for activating/de-activating the comparator and the voltage output stage 110. At first, when the determination circuit 130 is activated to detect the connection state between the connecting port 300 and the load, a voltage level of the enablement signal EN2 for the voltage output stage 110 is de-asserted, allowing the voltage output stage 110 to be turned off. Then, a voltage level of a control signal SW is asserted, allowing the switches SW1 and SW2 to be conductive. At this time, the reference current source 120, the output end E_OUT and the first resistor are electrically connected together. A voltage level of an enablement signal EN1 for the comparator is then asserted, activating the comparator. The comparator accordingly compares the second voltage signal V_THR with the first voltage signal V_OUT. After the comparator generates comparison result, the voltage level of the enablement signal EN1 is de-asserted, which makes the comparator stop operating. Afterwards, the voltage level of the control signal SW is de-asserted, which makes the switches SW1 and SW2 not conductive. As a consequence, the voltage level of the enablement signal EN2 of the voltage output stage 110 is asserted, allowing the voltage output stage 110 to enter the normal operation mode. Accordingly, the voltage output stage 110 is enabled to generate the output signal to connecting port 300 according to the signal generated by the signal processing circuit 140 (when the load is connected to the connecting port 300). Please note that, in other embodiments of the present invention, the switches SW1 and SW2 may be controlled by different control signals. As long as these control signals can make SW1 and SW2 conductive before the comparator is activated, the determination circuit 130 can correctly detect the connection state between the connecting port 300 and the load.

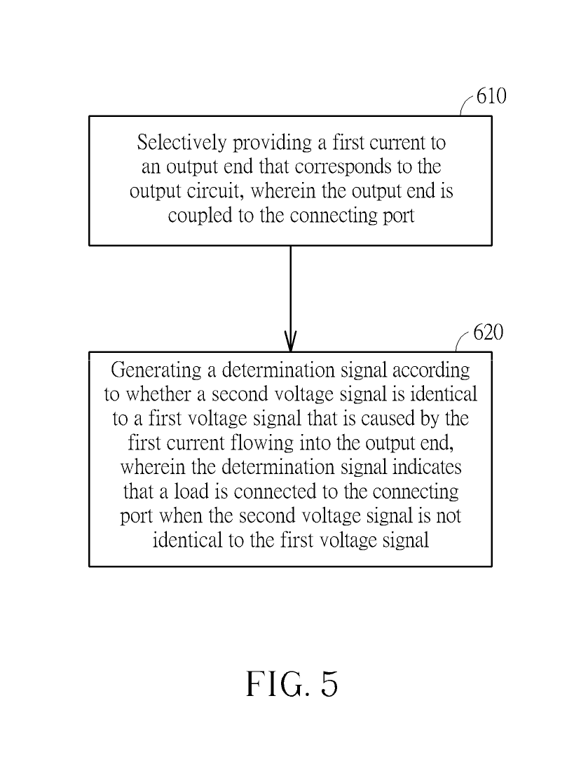

According to another embodiment of the present invention, a method of detecting whether a load is connected to a connecting port corresponding to an output circuit. Please refer to a flow chart of the method shown in FIG. 5. The method of the present invention comprises steps of:

Step 610: selectively providing a first current to an output end that is coupled to the output circuit, wherein the output end is coupled to the connecting port; and

Step 620: generating a determination signal according to whether a second voltage signal is identical to a first voltage signal that is caused by the first current flowing into the output end, wherein the determination signal indicates that a load is connected to the connecting port when the second voltage signal is not identical to the first voltage signal.

The above-mentioned output circuit and detection method can be used in any signal processing systems, including video processing systems. Typically, a video processing system needs front-stage circuits to perform demodulation, decoding and video adjustment operations on received video data. In a consequence, video signals generated by these front-stage circuits will be sent to back-stage circuits of the video processing system. The back-stage circuits process and output received video signals to a display device. The output circuit 100 of the present invention can be used as a part of these back-stage circuits, receiving the video signals from the front-stage circuits, and then converting and amplifying the received video signals. Even if the front-stage circuit outputs the video signal to the back-stage circuit, the back-stage circuit can turn off/de-activate its internal circuit blocks/modules or place them in a power saving mode as long as it detects the display device is not connected to the connecting port. As a result, the unnecessary power consumption can be saved.

The signal processing circuit 140 may be a digital to analog converter, which is used to convert digital video signals generated by the front-stage circuit into analog video signals. The voltage output stage 110 can be used to amplify the analog video signals. The amplified analog video signals will be transmitted to the display device through the transmission cable 400 which is connected to the connecting port 300. If the display device is not connected to the connecting port 300 via the transmission cable, the signal processing circuit 140 can be turned off. Even, some of the front-stage circuit (e.g. demodulation circuit, decoding circuit or video adjustment circuit) can be turned off or enter the power saving mode in accordance with the determination signal.

As can be understood from the above descriptions, the present invention detects the connection state between the load and the connecting port from the inside of the output circuit. Since the present invention does not use an external detection circuit to detect the variation of the voltages, it is unnecessary to assign additional signal pins for receiving the detection result. Therefore, the present invention reduces the manufacturing cost and simplifying the circuit complexity. Additionally, the detecting result of the connection state can be used to control operations of the circuit modules/blocks inside the output circuit. Under proper design and control, the present invention can further used to control the front-stage circuits, which can further reduce the power consumption of the whole system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An output circuit, comprising:
a voltage output stage, arranged to output a voltage signal to an output end of the output circuit, wherein the output end is coupled to a connecting port;
a reference current source, coupled to the output end, arranged to selectively provide a first current to the output end; and
a determination circuit, coupled to the output end, arranged to generate a determination signal according to whether a second voltage signal is identical to a first voltage signal that is caused by the first current flowing into the output end, wherein the determination signal indicates a load is connected to the connecting port when the second voltage signal is not identical to the first voltage signal.

2. The output circuit of claim 1, wherein the output circuit further comprises a signal processing circuit coupled to the determination circuit, and the signal processing circuit enters a power saving mode when the determination signal indicates the load is not connected to the connecting port.

3. The output circuit of claim 1, wherein the voltage output stage is turned off when the reference current source provides the first current to the output end.

4. The output circuit of claim 1, wherein the determination circuit comprises:
a comparator, coupled to the output end, arranged to compare the first voltage signal with the second voltage signal to determine whether the second voltage signal is identical to the first voltage signal, thereby generating the determination signal.

5. The output circuit of claim 1, wherein when there is a coupling capacitor coupled between the output end and the connecting port, the determination circuit generates the determination signal indicating that the load is connected to the connecting port if the first voltage signal is higher than the second voltage signal.

6. The output circuit of claim 1, wherein when there is no capacitor coupled between the output end and the connecting port, and the determination circuit generates the determination signal indicating the load is connected to the connecting port if the first voltage signal is lower than the second voltage signal.

7. The output circuit of claim 1, further comprising:
a resistive component, selectively being coupled to the output end, generating the first voltage signal by the first current flowing through the resistive component.

8. The output circuit of claim 7, wherein an amount of the second voltage signal is identical to a product of a resistance of the resistive component and an amount of the first current.

9. The output circuit of claim 7, wherein the amount of the second voltage signal is (i1+i3*k)*r, wherein r is the resistance of the resistive component, i1 is the amount of the first current, i3 is an amount of a third current flowing through the load, and k is a constant that is smaller than or equal to 1.

10. The output circuit of claim 7, wherein the amount of the second voltage signal is (i1−i3*k)*r, where r is the resistance of the resistive component, i1 is the amount of the first current, i3 is an amount of a third current flowing through the load, and k is a constant that is smaller than or equal to 1.

11. The output circuit of claim 7, wherein the amount of the second voltage signal is predetermined.

12. The output circuit of claim 7, wherein the output circuit further comprises:
a first switch, coupled between the output end and the resistive component, arranged to connect the output end to the resistive component when being conductive.

13. The output circuit of claim 1, wherein the output circuit further comprises:
a second switch, coupled between the output end and the reference current source, arranged to connect the output end to reference current source when being conductive.

14. A method of detecting whether a load is connected to a connecting port corresponding to an output circuit, comprising:
selectively providing a first current to an output end, wherein the output end is coupled to the connecting port; and
generating a determination signal according to whether a second voltage signal is identical to a first voltage signal that is caused by the first current flowing into the output end, wherein the determination signal indicates the load is connected to the connecting port when the second voltage signal is not identical to the first voltage signal.

15. The method of claim 14, further comprising:
allowing a signal processing circuit in the output circuit to enter a power saving mode when the determination signal indicates the load is not connected to the connecting port.

16. The method of claim 14, further comprising:
providing the first current to the output end, and turning off a voltage output stage of the output circuit; and
stopping providing the first current to the output end, and turning on the voltage output stage.

17. The method of claim 14, wherein there is a coupling capacitor coupled between the output end and the connecting port, and the step of generating the determination signal comprises:
generating the determination signal indicative of the load being connected to the connecting port when the first voltage signal is higher than the second voltage signal.

18. The method of claim 14, wherein there is no capacitor coupled between the output end and the connecting port, and the step of generating the determination signal comprises:
generating the determination signal indicative of the load being connected to the connecting port when the first voltage signal is lower than the second voltage signal.

19. The method of claim 14, further comprising:
providing an resistive component to be selectively coupled to the output end; and
generating the first voltage signal by allowing the first current to flow through the resistive component.

20. The method of claim 19, wherein an amount of the second voltage signal is identical to a product of a resistance of the resistive component and an amount of the first current.

21. The method of claim 19, wherein the amount of the second voltage signal is (i1+i3*k)*r, where r is the resistance of the resistive component, i1 is the amount of the first current, i3 is an amount of a third current flowing through the load, and k is a constant that is smaller than or equal to 1.

22. The method of claim 19, wherein the amount of the second voltage signal is (i1−i3*k)*r, where r is the resistance of the resistive component, i1 is the amount of the first current, i3 is an amount of a third current flowing through the load, k is a constant that is smaller than or equal to 1.

23. The method of claim 19, the amount of the second voltage signal is predetermined.

24. A video output circuit for outputting a video output signal, comprising:
a digital-to-analog converter, arranged to convert a digital video signal into an analog video signal;
a voltage output stage, coupled to the digital-to-analog converter, arranged to receive the analog video signal and generate the video output signal to an output end corresponding to the output circuit, wherein the output end coupled to is coupled to a connecting port;
a reference current source, coupled to the output end, arranged to selectively provide a first current to the output end; and
a determination circuit, coupled to the output end, arranged to generate a determination signal according to whether a second voltage signal is identical to a first voltage signal that is caused by the first current flowing into the output end, wherein the determination circuit generates the determination signal indicating a load is connected to the connecting port when the second voltage signal is not identical to the first voltage signal, thereby allowing the digital-to-analog converter to enter a power saving mode.
